(19) United States
(12) Patent Application Publication
(10) Pub. No.: US 2012/0104826 A1
(43) Pub. Date: May 3, 2012

(54) OCCUPANT RESTRAINT SYSTEM COMPONENTS HAVING STATUS INDICATORS AND/OR MEDIA INTERFACES, AND ASSOCIATED METHODS OF USE AND MANUFACTURE

(75) Inventors: Peter Edward Miller, Phoenix, AZ (US); Ian John Hadlow, Worcester (GB); Derrick John Martin Barker, Bishampton (GB); Andrew Charles Peters, Bromsgrove (GB); Sean Leonard Rory Casey, Waterlooville (GB)

(73) Assignee: AmSafe Commercial Products, Inc., Elkhart, IN (US)

(21) Appl. No.: 13/234,106

(22) Filed: Sep. 15, 2011

Related U.S. Application Data
(60) Provisional application No. 61/383,264, filed on Sep. 15, 2010.

(51) Int. Cl. B60N 2/26; B60R 22/00

(52) U.S. Cl. 297/464; 24/593.1

(57) ABSTRACT

The present disclosure describes components for use with child seats and other personal restraint systems. In one embodiment a soft pad portion of a buckle assembly can be configured to surround or encase components of a buckle assembly of a personal restraint system. In certain embodiments of the disclosure, the pad can include one or more media features that can include entertainment, education, or care-giver alert devices that can be attached to, integrated with, or otherwise connected to the pad. Moreover, the pad can also serve as a platform onto which indicators, additional user devices, and/or media features can be incorporated and/or displayed.

### CROSS-REFERENCE TO RELATED APPLICATION(S) INCORPORATED BY REFERENCE

The present application claims the benefit of and priority to U.S. Provisional Patent Application No. 61/383,264, filed Sep. 15, 2010 and incorporated herein in its entirety by reference.

### TECHNICAL FIELD

The following disclosure relates generally to occupant restraint systems for use in vehicles and, more particularly, to buckle assemblies and associated components having status indicators and/or media interfaces for use with child seats and other personal restraint systems.

### BACKGROUND

There are many types of personal restraint systems for use in automobiles, aircraft, all-terrain-vehicles, and other vehicles. Such systems include, for example, seat belts for use by adults and children of sufficient size, and child seats with associated restraints for use by toddlers and small children.

One method of securing the seat belts or webs around an occupant includes releasably attaching an end portion of each of the webs to a buckle assembly. The buckle assembly retains the webs around the occupant during use, and also enables the occupant to release or separate the webs after use. Conventional buckle assemblies can be positioned to the side of an occupant or in front of an occupant. For example, a “three point” harness system, as typically found in conventional automobiles, can include a shoulder web and a lap web that are releasably secured to a buckle assembly positioned proximate to the occupant's hip. A “five point” harness system can include a crotch web, first and second shoulder webs, and first and second lap webs that are releasably secured to a buckle assembly positioned proximate to the occupant's mid-section.

### BRIEF DESCRIPTION OF THE DRAWINGS

FIG. 1 is an isometric view of a child secured in a child seat with a restraint system having a buckle assembly configured in accordance with an embodiment of the disclosure.

FIG. 2 is an enlarged isometric view of the buckle assembly of FIG. 1.

FIG. 3A is a front isometric view of a pad portion of the buckle assembly of FIG. 1, FIG. 3B is a rear view of the pad portion, and FIGS. 3C-3I are front isometric views of buckle assemblies configured in accordance with other embodiments of the disclosure.

FIGS. 4 and 5 are isometric views of buckle assemblies configured in accordance with further embodiments of the disclosure.

FIG. 6 is a front isometric view of a buckle assembly configured in accordance with still further embodiments of the disclosure.

FIGS. 7A-7C are isometric views of safety seat support frames and associated buckle assemblies configured in accordance with other embodiments of the disclosure.

FIGS. 8A and 8B are enlarged side views of connectors from the support frames of FIGS. 7A-7C.

FIG. 9 is a bottom isometric view of a portion of a safety seat support frame configured in accordance with another embodiment of the disclosure.

FIG. 10 is a rear isometric view of a portion of a safety seat support frame configured in accordance with a further embodiment of the disclosure.

FIGS. 11A and 11B are schematic diagrams of electrical circuits having one or more illuminators and/or indicators configured in accordance with embodiments of the disclosure.

### DETAILED DESCRIPTION

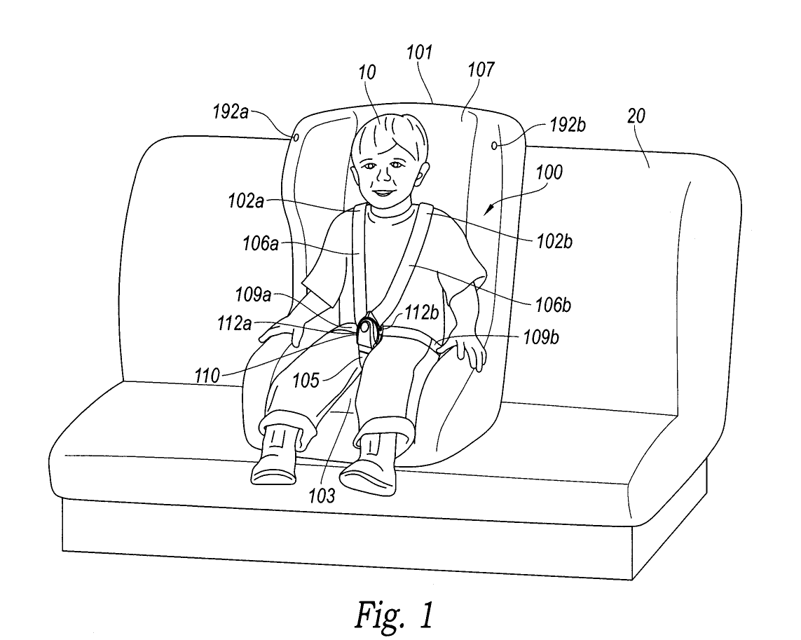

The following disclosure describes soft and/or padded components and associated media interfaces and/or status indicators for use with child seats and other personal restraint systems. As described in greater detail below, in one embodiment a soft pad portion of a buckle assembly can be configured to surround or encase components of the buckle assembly. Certain details are set forth in the following description and in FIGS. 1-11B to provide a thorough understanding of various embodiments of the disclosure. However, other details describing well-known structures and systems often associated with buckle assemblies, web connectors, pads, and/or other aspects of personal restraint systems are not set forth below to avoid unnecessarily obscuring the description of various embodiments of the disclosure.

Many of the details, dimensions, angles, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

In the Figures, identical reference numbers identify identical or at least generally similar elements. To facilitate the discussion of any particular element, the most significant digit or digits of any reference number usually refers to the Figure in which that element is first introduced. For example, element 110 is first introduced and discussed with reference to FIG. 1.

FIG. 1 is an isometric view illustrating a restraint system 100 having a buckle assembly 110 with a soft, padded encasement configured in accordance with an embodiment of the disclosure. In the illustrated embodiment, the restraint system 100 holds a vehicle occupant 10 (e.g., a child) in a child seat 101. In other embodiments, however, the restraint system 100 and associated buckle assembly 110 can restrain any type of occupant in a vehicle without a child seat 101. In still further embodiments, the buckle assembly 110 can restrain the occupant 10 in a high-chair, a swing, a bicycle, a stroller, or other seat. In the illustrated embodiment, the child seat 101 includes a base portion 103 and a back portion 107. The child seat 101 can be secured to a vehicle seat 20 using various systems known in the art. Such systems can include, for example, belts or webs (not shown) having proximal ends attached to the child seat 101 and distal ends attached to anchors (also not shown) in the bight of the vehicle seat 20 with suitable couplings. In other embodiments, the child seat 101 can be secured to the vehicle seat 20, and/or other vehicle structures, using other suitable methods known in the art. Moreover, in further embodiments the child seat 101 or variations thereof can be reversed so that the child seat 101 is facing rearward toward the vehicle seat 20. In still further embodiments, the status indicators 192a and 192b can be disposed on the child seat 101 and can be configured to display colors to indicate, for example, a secure locking of buckle assembly 110. Accordingly, as the foregoing illustrates, embodiments of the present disclosure and applications of the buckle assemblies and web connectors disclosed herein are not limited to the particular child seat configuration illustrated in FIG. 1.

In the illustrated embodiment, the restraint system 100 includes a first shoulder web 102a and a second shoulder web 102b extending from the back portion 107 of the child seat 101. The shoulder webs 102 can include various types of woven fabric materials and/or other suitable belt or strap materials known in the art that provide sufficient strength, flexibility, durability and/or other characteristics. In this embodiment, each of the shoulder webs 102 slidably passes through an aperture in a corresponding web connector 112 (identified individually as a first web connector 112a and a second web connector 112b). Passing the shoulder webs 102 through the web connectors 112 divides each of the shoulder webs 102 into a corresponding shoulder web portion 106 (identified individually as a first shoulder web portion 106a and a second shoulder web portion 106b), and a corresponding lap web portion 109 (identified individually as a first lap web portion 109a and a second lap web portion 109b). The end portions of the shoulder webs 102 can be secured or otherwise affixed to the child seat 101 and/or other adjacent structures using various methods known in the art.

In the illustrated embodiment, the web connectors 112a and 112b releasably engage the buckle assembly 110, which is further attached to a distal end portion of a crotch web 105 that extends from the base portion 103 of the child seat 101. The proximal end portion of the crotch web 105 can be secured to the child seat 101 and/or other adjacent structures using various methods known in the art. Although FIG. 1 illustrates one possible use of the buckle assembly 110, those of ordinary skill in the art will appreciate that the buckle assembly 110 and the other components of the restraint system 100 can be used in a number of other restraint system applications without departing from the spirit or scope of the present disclosure.

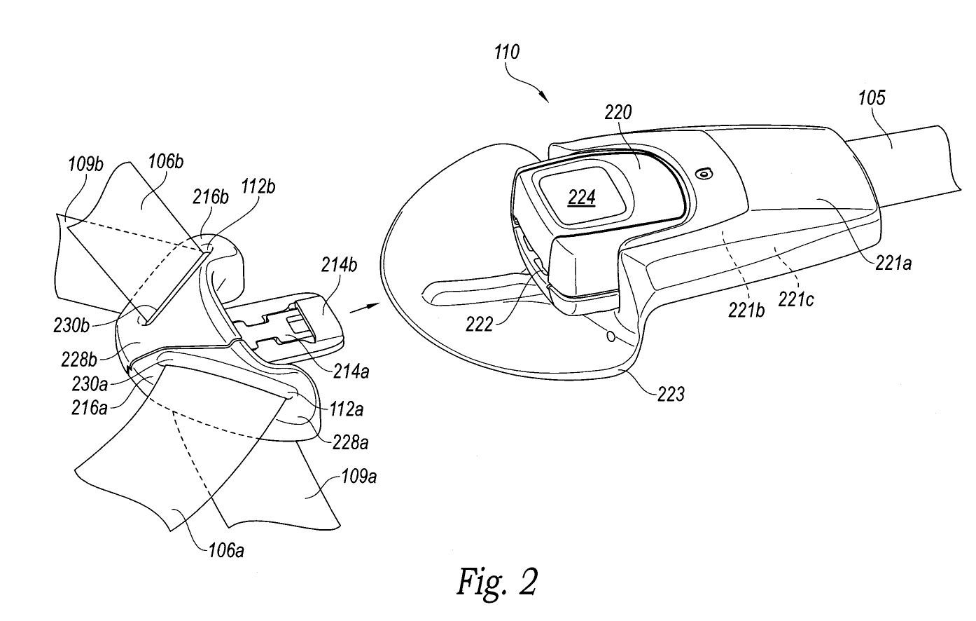

FIG. 2 is an enlarged isometric view of the buckle assembly 110 of FIG. 1 positioned in a padded pouch or enclosure, such as a casing 223 configured in accordance with an embodiment of the disclosure. Each of the web connectors 112 includes a tongue 214 (identified individually as a first tongue 214a and a second tongue 214b) and a corresponding web receiving portion 216 (identified individually as a first web receiving portion 216a and a second web receiving portion 216b). The tongues 214 can include engagement features (e.g. apertures) that are configured to releasably engage corresponding locking features in the buckle assembly 110. Various types of suitable engagement features and corresponding locking features are known in the art and can be used with the embodiments described herein. In the illustrated embodiment, the web connectors 112 can be configured to be mated or interlocked with one another so that the tongues 214 can be simultaneously inserted into the buckle assembly 110. In other embodiments, however, the web connectors 112 can be configured to be inserted separately into the buckle assembly 110. Each of the web receiving portions 216 can also include a corresponding aperture 230a and 230 b through which the corresponding shoulder web 106 passes. Each of the web connectors 112 can include a cover 228 (identified individually as a first connector cover 228a and a second connector cover 228b), such as a plastic cover, that fits over the respective web receiving portion 216.

The buckle assembly can include a body or a housing 220 having a tongue opening 222 configured to receive the tongues 214 when the buckle assembly 110 is in an engaged configuration. The buckle assembly 110 can also include a release actuator or a button 224, configured to release or disengage the tongues 214 from locking features of the buckle assembly 110 when a user depresses or otherwise actuates the button 224.

Various portions of the web connectors 112 and the buckle assembly 110 can be made of plastic, metal, textiles, or other suitable materials known in the art, or can be a combination of various materials. For example, in one embodiment, such components can be made as described in U.S. Patent Application No. 61/258,110, entitled “RESTRAINT SYSTEM BUCKLE COMPONENTS HAVING TACTILE SURFACES, AND ASSOCIATED METHODS OF USE AND MANUFACTURE,” filed Nov. 4, 2009, and/or U.S. Patent Application No. 61/259,848, entitled “BUCKLE ASSEMBLIES FOR PERSONAL RESTRAINT SYSTEMS AND ASSOCIATED METHODS OF USE AND MANUFACTURE,” filed Nov. 10, 2009, and/or U.S. patent application Ser. No. 12/357,356, entitled “BUCKLE ASSEMBLIES AND ASSOCIATED CONNECTORS FOR USE WITH CHILD SEATS AND OTHER RESTRAINT SYSTEMS,” filed Jan. 21, 2009, all of which are incorporated herein by reference in their entireties. Moreover, portions of the housing 220, the button 224 and the web connectors 112 can include a durable finish that facilitates grasping and/or manipulation of these components.

In one aspect of this embodiment, the casing 223 can have a first or front side portion 221a opposite a second or rear side portion 221b. The casing 223 can further include a cavity, pocket, or interior portion 221c configured to receive and hold the buckle assembly 110. In other embodiments, the interior portion 221c can be configured to additionally or alternately receive and hold or retain other portions of the buckle assembly 110.

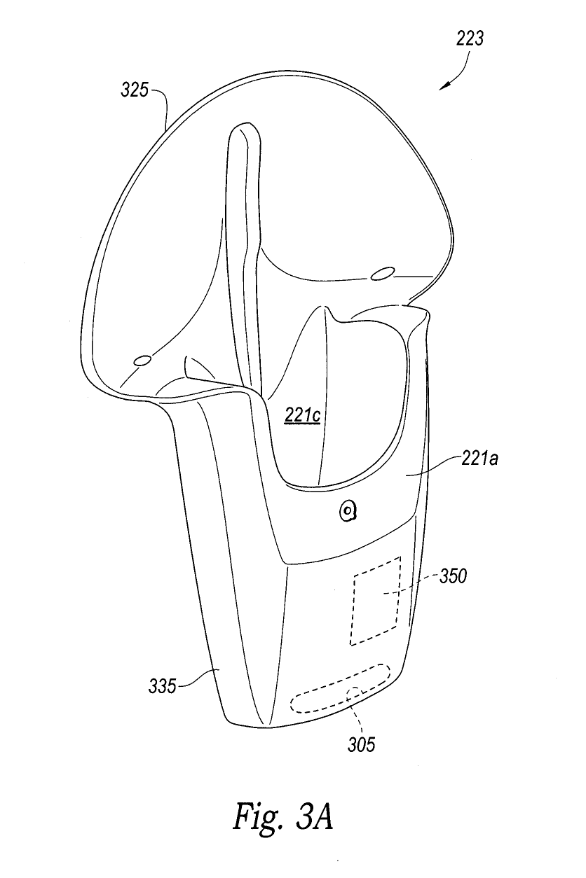

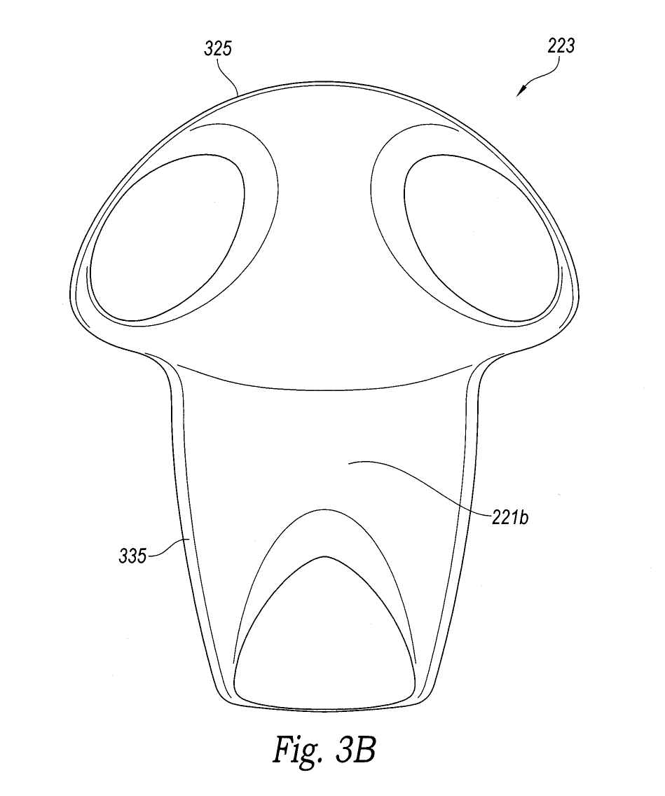

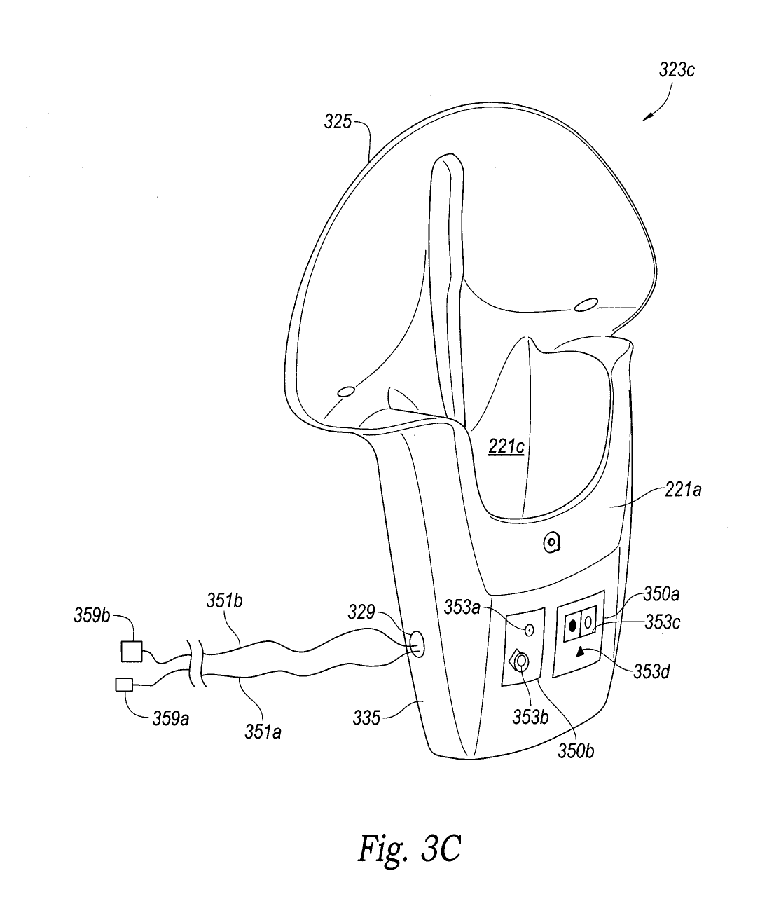

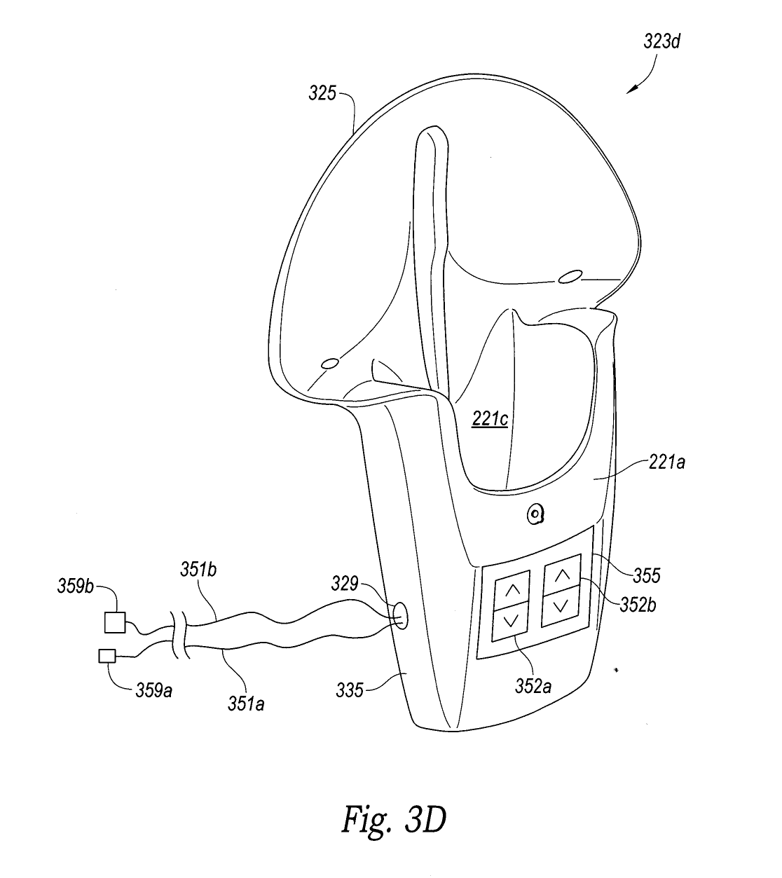

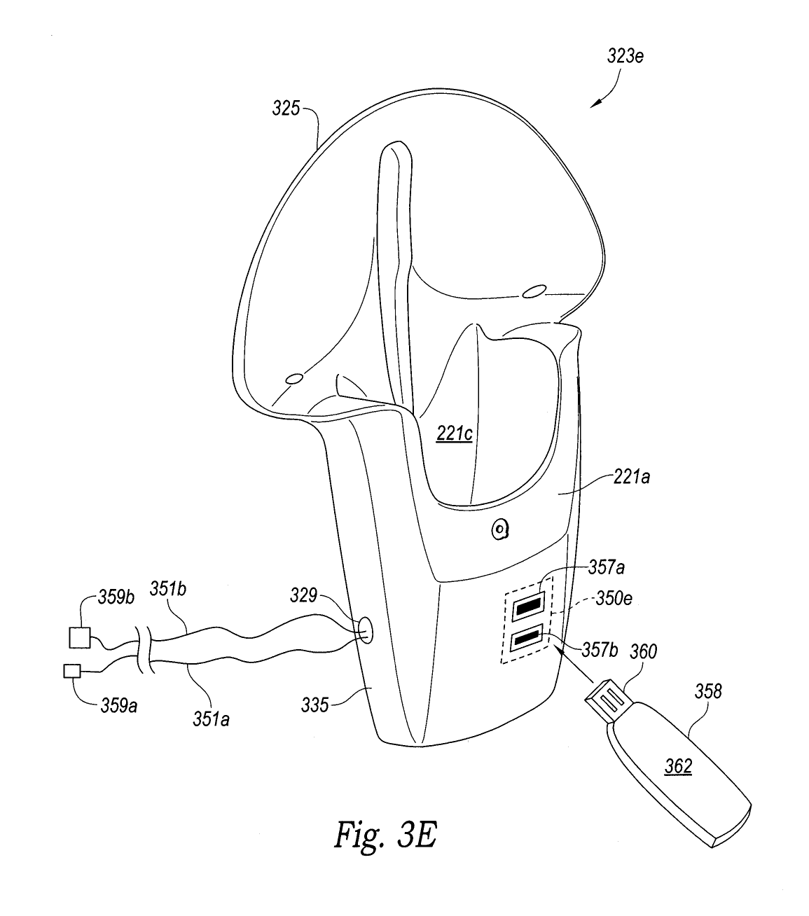

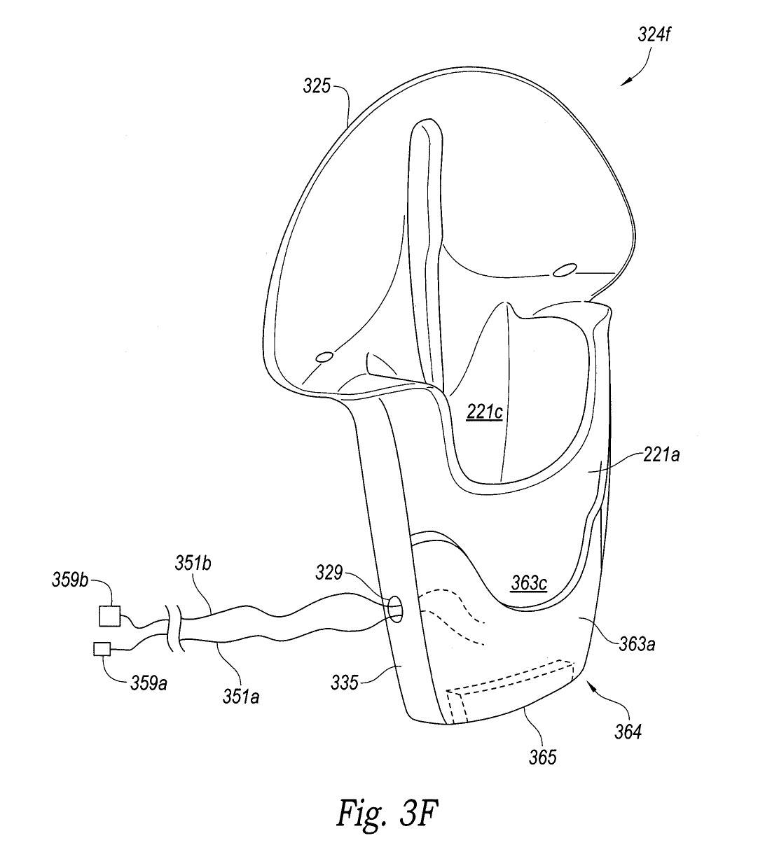

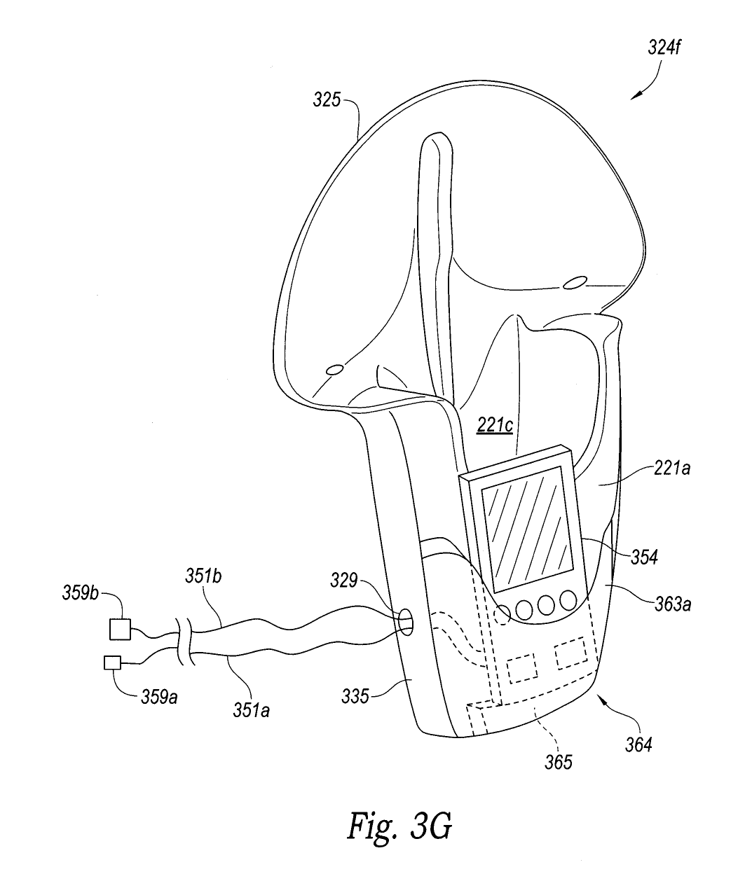

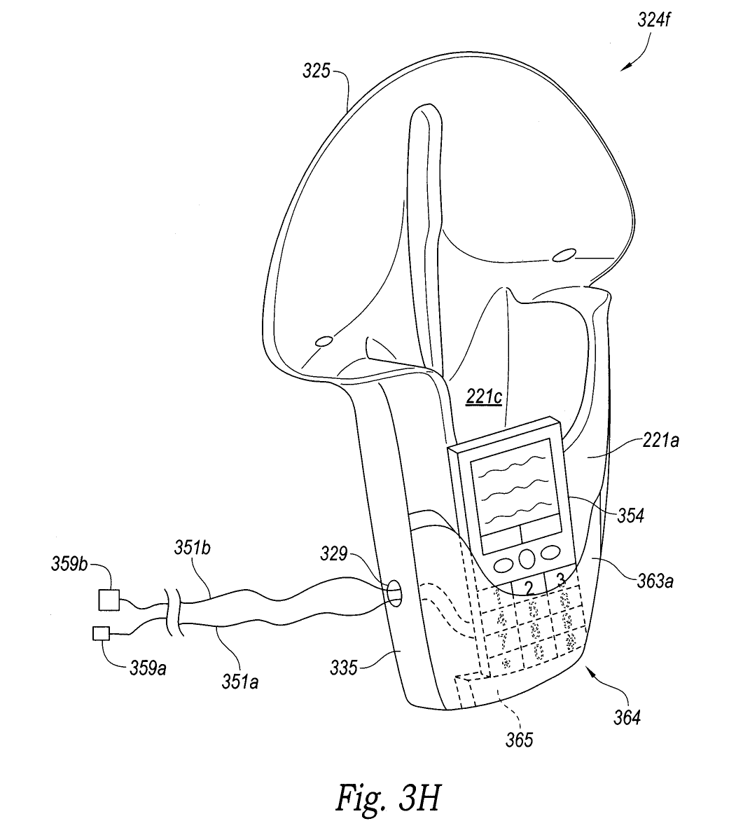

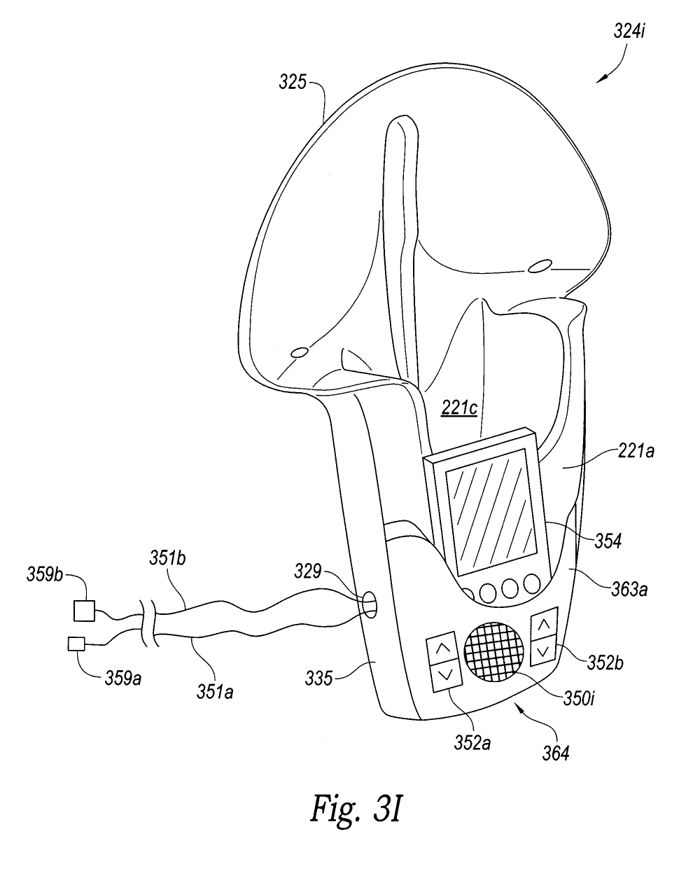

FIG. 3A is a front isometric view of the casing 223 of FIG. 2, and FIG. 3B is a rear view of the casing 223. Referring to FIGS. 3A and 3B together, the interior portion 221c is configured to accept and at least partially surround or encase the buckle assembly 110. In one embodiment, the casing 223 can hold the buckle assembly 100 and/or web connectors 112 by frictional force, elastic straps, or a snug fitting of the casing 223 surrounding the buckle assembly 110. In other embodiments, the buckle assembly 100 can be releasably or fixably attached to the pad by any type of connector known in the art, including, for example, snaps, screws, magnets, adhesive, etc. In other embodiments, the casing 223 can be integrally formed with the buckle assembly 110. The casing 223 can also have an opening 305 through which the crotch webbing 105 can be fed and attached to the buckle assembly 110. In some embodiments, the casing 223 encloses an upper portion of the buckle assembly 110 and is configured to have apertures or cutouts so that, for example, the web connectors 206 can slidably pass through the casing 223 and tongue opening 222 and engage the locking features in the buckle assembly 110.

The casing 223 can have a plurality of different shapes as appropriate for the intended aesthetic and functional applications. For example, the illustrated casing 223 includes an upper portion 325 having a semi-rounded shape and a lower portion 335 with a semi-rectangular shape. In other embodiments, the casing 223 may be more or less rounded, circular, rectangular, triangular, a combination of these, or another shape entirely.

At least a portion of the casing 223 can be made of various types of soft materials known in the art. For example, in some embodiments the casing 223 or a portion thereof can be made of soft plastic, artificial rubber (e.g., synthetic, molded rubber), foam (e.g., EVA foam), elastomeric material, fabric, batting, and/or other soft and compressible material. The exterior of the pad 221 can be covered in various types of fabric or other outer covering, such as suede, leather, velvet, silk, cotton, rubber, vinyl, mesh, etc. The many fabric/padding options allows a designer to select materials having a desired texture—smooth, grip-friendly, tactile, compliant, etc.—and/or aesthetic quality.

An advantage of some embodiments is that the casing 223 provides a soft surface against the occupant. Another advantage of certain embodiments of the casing 223 is that the buckle assembly 110 may be removed from the casing 223 and the casing 223 can be washed. The casing 223 has the additional advantage of further increasing the design options of the buckle assembly 110. For example, in some embodiments the casing 223 can include one or more compartments or pockets (not pictured) for storing toys or other items. In other embodiments the casing 223 can be designed with fabric or other media having a child-themed appearance.

In some embodiments, a portion of the casing 223 can be made of a hard plastic or a low-friction textile. For example, in one embodiment, at least a portion of the front side portion 221a of the pad can be made of smooth plastic in order to reduce friction when tensioning the webbing or inserting the tongues while at least a portion of the back side 221b (which contacts the occupant) can be made of a soft, comfortable material.

In certain embodiments of the disclosure, the casing 223 can include one or more media features 350 (shown schematically in FIG. 3A). For example, the media feature 350 can include entertainment, education, or care-giver alert devices that can be attached to, integrated with, or otherwise connected to the casing 223. Moreover, the casing 223 can serve as a platform onto which additional user devices and/or media features can be incorporated and/or displayed. For instance, lights and/or audio devices can be incorporated into the casing 223 to provide indications of the latched/released status of the tongues 214 (FIG. 2) in the buckle assembly 110. In another embodiment, the media feature 350 can include an audio or visual output. For example, the media feature 350 can be an MP3 or MP4 player, or a port thereon for connection to an MP3 or MP4 player. Video and/or audio jacks can also be incorporated into the casing 223. In still further embodiments, a USB flash device can store audio or video files on the media feature 350. The media feature 350 can either be placed or molded into the casing 223 or it can be externally mounted or connected to the casing 223. The media feature 350 can also receive electrical power from an exterior source, such as a vehicle system, or can have an internal power source, such as a battery

FIG. 3C depicts a front isometric view of a casing 323c having a first media feature 350a and a second media feature 350b, configured in accordance with some embodiments of the disclosure. In the illustrated embodiment, the first media feature 350a includes an electrical power control 353c and an electrical power status indicator 353d, and the second media feature 350b includes an audio interface 353a and a video interface 353b. The electrical power control 353c can be, for example, a switch or a button, configured to allow electrical power flow to and/or from the casing 323c in an “on” state and not allow electrical power flow in an “off” state. The electrical power status indicator can be, for example, a light and/or a light emitting diode (LED) configured to display at least a first color when the electrical power control 353c is an “on” state. The audio interface 353a and the video interface 353b are configured to input and/or output audio and video signals, respectively. The audio interface 353a can be, for example, an auxiliary input configured to receive an audio output signal of an external device, such as an MP3 player. The video interface 353b can be, for example, a component video input configured to receive the video signal of an external device.

The first media feature 350a and the second media feature 350b can be electrically coupled to one or more wires 351 (identified individually as a first wire 351a and a second wire 351b) passing through an aperture 329 in a side portion of the casing 323. The wires 351 can be configured to transmit the audio and video signals to and from the audio interface 353a and the video interface 353b, respectively. The wires 351 can also be configured to transmit other information, for example, child safety seat status, Internet data, and/or device control signals, to an external vehicle system. The wires 351 can further be configured to deliver electrical power to the first media feature 350a and the second media feature 350b from an external power source. One or more wire interfaces 359 (e.g. a conventional electrical connector, tack, etc.; identified individually as a first wire interface 359a and a second wire interface 359b) can be coupled to the wires 351, and can be configured to interface with any number of external systems to provide power, audio, video, operational signals, and/or other signals to the external systems.

FIG. 3D is a front isometric view of a casing 323d having a user interface 355 configured in accordance with another embodiment of the disclosure. In the illustrated embodiment, the user interface 355 includes a first control 352a and a second control 352b disposed on the front side portion 221a. The first and second controls 352 can be configured to operate any number of features in an external system, for example, a vehicle audio playback system and/or vehicle air conditioning system. In some embodiments, for example, the controls 352 may be configured to control volume and/or channel features of an external audio and/or visual display system (e.g. video on a DVD display). The audio and/or visual display system can include, for example, audio playback through headphones worn by a user and video playback on a video display integrated into the vehicle. In other embodiments, the controls 352 may be configured to control, for example, cellular phone features such as initiating or ending a cellular phone call. In further embodiments, the controls 352 may be configured to control any number of features, for example, air temperature and/or fan speed of a vehicle air conditioning system. The controls 352 can be configured to interface with the external system via the wires 351. In certain embodiments, the controls 352 can also be configured to interface with, for example, a vehicle system or a handheld media device in use by an occupant of the safety seat 101, via wireless signal transmission (e.g., RF signals) (not shown).

FIG. 3E is a front isometric view of a casing 323e having one or more media interfaces 357 (identified separately as a first media interface 357a and a second media interface 357b), configured in accordance with another embodiment of the disclosure. The media interfaces 357 can be, for example, USB and/or headphone ports. The media interfaces 357 can be configured to receive a media device 358 having a device interface 360. The media device 358 can be, for example, a USB flash storage device, portable audio device, cellular telephone, or any other mobile media storage device. The device interface 360 can be, for example, a USB connector and/or a headphone jack. The device interface 360 can be configured to be releasably inserted into one of the media interfaces 357, thereby transferring media 362 from the media device 358 to an external system, for example, an audio and/or visual display in use by an occupant of the safety seat 101. In some embodiments the media 362 can comprise digital audio, for example, music and/or spoken word recordings. In other embodiments, however, the media 362 can comprise audio and visual information, for example, a motion picture and/or a television program. In further embodiments, the media 362 can comprise, for example, a set of navigation coordinates to be input into a vehicle navigation system. In yet further embodiments, the media 362 can comprise, for example, electronic books and/or magazines, which can be output to an external display. In some further embodiments, the media 362 can be transferred from the media device 358 to the external system via the wires 351. In other embodiments, the media 362 can be transmitted to an external system via wireless transmission (not shown). In certain embodiments, the media 362 is transmitted to a vehicle system, while in certain other embodiments, the media 362 is transmitted to, for example, a personal media playback device, a cellular phone, and/or a personal computing device. In certain other embodiments, external media, such as audio and/or visual information can be transmitted to the media device 358.

FIGS. 3F-3H are front isometric views of a casing 324f configured in accordance with an embodiment of the disclosure. Referring first to FIG. 3F, an enclosure, such as a pocket or a media receptacle 364, is disposed on at least a portion of the casing 324. In the illustrated embodiment of FIG. 3F, the media receptacle 364 has a front portion 363a and an interior portion 363c, and can be configured to be a docking station into which a handheld and/or portable user device may be inserted. A receptacle interface 365 (e.g. a handheld device cable or dock interface) can be disposed in the interior portion 363c of the media receptacle 364 and can be configured to be electrically coupled to the device. In one embodiment, the receptacle interface 365 can have a plurality of pins configured to be inserted into the base of the device, for example the dock interface of a personal audio device. In another embodiment, the receptacle interface 365 can have an aperture (e.g. a port or a slot) into which a portion of the device can be releasably joined, for example a USB port. In a further example, the receptacle interface 365 can have a cable with a plug that can be releasably inserted into a port of the device, for example a USB and/or power supply cable. The media receptacle 364 can be configured to provide electrical power to the device and/or connect the device into an electrical system of the vehicle via the receptacle interface 365 and the wires 351.

Referring next to FIG. 3G, a media device 354 capable of audio and/or visual playback (e.g. an MP3 player and/or a DVD player) is releasably disposed in the media receptacle 364 of the casing 324f. The media device 354 can be releasably connected to the receptacle interface 365 allowing, for example, an external power source to supply electrical power to the media device 354. Audio and/or visual media (e.g. songs, audio books, television programs, and/or motion pictures) contained on the media device 354 can also be transmitted to an external playback system (e.g. a vehicle audio system or a video display) via the media interface 365 through, for example, the wires 351 or wireless signal transmission (e.g. RF signals). In some embodiments, media information, (e.g. track artist, name, length, etc.) can be transmitted from the media device 354 via the media interface 365 to the external playback system. In other embodiments, the media interface 365 can be further configured to connect the media device 354 to the external playback system to allow, for example, control of the media device 354 by a user via an interface in the external playback system.

In the illustrated embodiment of FIG. 3H, the media device 354 is a handheld device, such as a cellular telephone, releasably disposed in the media receptacle 364 of the casing 324f and releasably connected to the media interface 365. The media interface 365 can be, for example, a cable releasably inserted into a port of the media device 354. The media interface 365 can be configured to interactively couple the media device 354 to an external system (e.g. a control interface in and/or on a vehicle in-dash display) configured to allow one or more users to control features of the media device 354 and/or to present call information on the display. In some embodiments, the media receptacle 364 can be further configured to be an Internet connectivity device (i.e. a wireless signal hotspot) such that Internet data from a cellular telephone inserted therein can be utilized by one or more nearby devices. For example, a cellular telephone having a cellular Internet data plan can be inserted into the media receptacle 364 whereupon a local area network (LAN) is established thereby allowing Internet connectivity to, for example, a personal laptop computer in use by a passenger of a vehicle.

FIG. 3I is a front isometric view of a casing 324i, configured in accordance with yet another embodiment of the disclosure. The casing 325 includes the controls 352 and a media feature 350i, all disposed on the front face 363a of the media receptacle 364. The media device 354 is releasably disposed within the media receptacle 364 and can be connected to the media feature 350i via the media interface 365 (FIG. 3F). The controls 352 are configured to control playback features of media output to the media feature 350i and/or an external playback system. The controls 352 can include, for example, volume control, an audio track control (e.g. track selection, album selection, track fast forward, or track rewind), a video track control (e.g. scene selection) or radio tuning control (e.g. AM/FM band selection). In the illustrated embodiment of FIG. 3I, the media feature 350i is configured to be an audio display (e.g. a speaker) that can output audio from the media device 354. In other embodiments, the media feature 350i can be another media display, such as a video display and/or a notification panel.

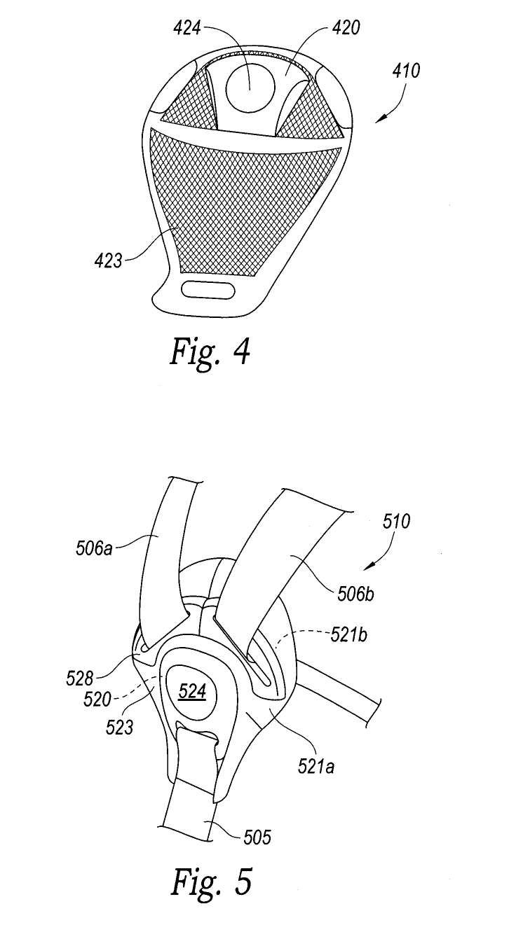

FIGS. 4 and 5 are isometric views of buckle assemblies 410 and 510, respectively, configured in accordance with further embodiments of the disclosure. FIG. 4 illustrates a buckle assembly 410 having a casing 423 (the shoulder and crotch webs have been omitted from FIG. 4 for the purposes of clarity). In this embodiment, the casing 423 can be made from a washable mesh fabric and/or other materials, such as plastic, vinyl, or leather. The buckle assembly 410 can include a housing 420 and a release button 424. The buckle assembly 410 can also include features and properties similar to the buckle assemblies described above with reference to FIGS. 1-3I.

FIG. 5 illustrates still another embodiment of a buckle assembly 510 having many features similar in structure and function to the assemblies previously described with reference to FIGS. 1-3i, including a housing 520, a casing 523, a release button 524, a set of connector covers 528, a crotch web 505, and shoulder webs 506 (referred to separately as a first shoulder web 506a and a second shoulder web 506b). The casing 523 can be configured to accept and at least partially surround the buckle assembly 510 while still allowing release button 524 to be accessible and the shoulder webs 506 and crotch web 505 to slidably pass therethrough. In the illustrated embodiment, the casing 523 encases the buckle assembly 510 and the housing 520. The casing 523 can include a lower portion and an upper portion with openings (e.g. apertures, slots, and/or cutouts) through which the crotch web 505 and the shoulder webs 506, respectively, can be fed and attached to the buckle assembly 110. The openings in the upper portion of the casing 523 further allow web connectors operably coupled to the shoulder webs 506 to slidably pass therethrough to a tongue opening (not shown) in the housing 520 and engage the locking features in the buckle assembly 510. An additional opening in the casing 523 can allow access to the release button 524, which can be configured to release or disengage the web connectors of the shoulder webs 506 from the locking features of the buckle assembly 510 when a user depresses or otherwise actuates the release button 524.

In the illustrated embodiment, casing 523 has a semi-rounded shape. However, in other embodiments, the casing 523 may be more or less rounded, circular, rectangular, triangular, a combination of these, or another shape entirely. Furthermore, in some embodiments, a rear side portion 521b of the casing 523 can include a soft, padded material and a front side portion 521a can include a hard, low-friction plastic, soft plastic, artificial rubber (e.g., synthetic, molded rubber), foam (e.g., EVA foam), elastomeric material, fabric, batting, and/or other soft and compressible material. For example, in one embodiment, at least a portion of the front side portion 521a of the pad can be made of smooth plastic in order to reduce friction when tensioning the shoulder webs 506 and/or crotch web 505 or inserting the tongues, while at least a portion of the back side 521b (which contacts the occupant) can be made of a soft, comfortable material.

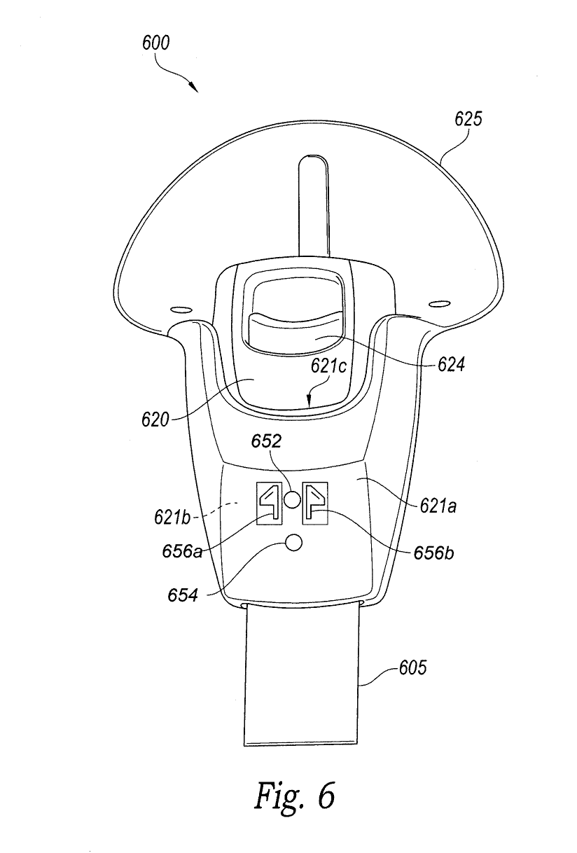

FIG. 6 illustrates a front isometric view of a further embodiment of a buckle assembly 610 configured in accordance with the disclosure. The buckle assembly 610 also has many features that are similar in structure and function to the buckle assemblies described in detail above, including, for example, a housing 620, a casing 623, a release button 624, and a web 605. The casing 623 includes a front side portion 621a, a rear side portion 621b, and an interior portion 621c. In one aspect of the illustrated embodiment, a first indicator 652, a second indicator 654, a first symbol 656a, and a second symbol 656b are disposed on a front face of the front side portion 621a. The first indicator 652 and the second indicator 654 can be, for example, a light emitting diode (LED) or another light source, and can be configured to activate based on one or more status conditions. For example, the first indicator 652 and the second indicator 654 can be configured to visually display different colors depending on the latched/released status of one or more tongues (not shown) positioned in the housing 620. If, for example, the one or more tongues are properly latched in the housing 620, the second indicator 654 may display a first color (e.g. a green color). However, if, for example, the tongue is not securely engaged and latched in the housing 620, the first indicator 652 may visually display a second color (e.g. a red color). In other embodiments, the first indicator 652 and the second indicator 654 may display other colors such as, for example, yellow.

In some embodiments, the first indicator 652 and the second indicator 654 may correspond to the status of child restraint system components denoted by the first symbol 656a and the second symbol 656b. For example, the first indicator 652 and/or the second indicator 654 can be configured to activate (e.g. illuminate) in response to the status of the attachment of a child seat 101 (FIG. 1) to a plurality of anchors in the bight or other portions of the vehicle seat 20 (FIG. 1). In another embodiment, the first indicator 652 and/or the second indicator 654 may be configured to activate in response to the tension of the web 605 coupled reaching a preset limit or point. In further embodiments, the first indicator 652 and/or the second indicator 654 may be configured to activate in response to conditions external to the child restraint system (e.g. a locked status of a vehicle door). In some embodiments, the first indicator 652 and/or the second indicator 654 may have a constant visual display unless a status condition occurs. For example, the second indicator 654 can be configured to constantly display the second color unless the one or more tongues are securely latched in the housing 620. In certain other embodiments, while in other embodiments the first indicator 652 and/or the second indicator 654 may be configured to flash or otherwise operate intermittently. In some other embodiments, there may be only one indicator 652 while in other embodiments there may be 2 or more indicators 652.

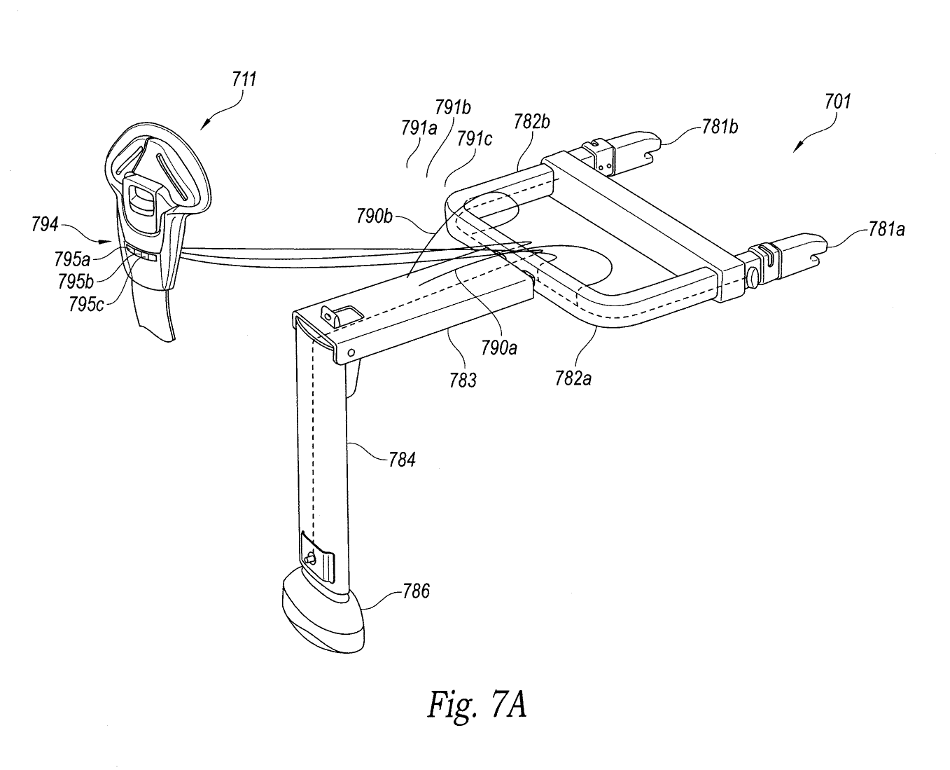

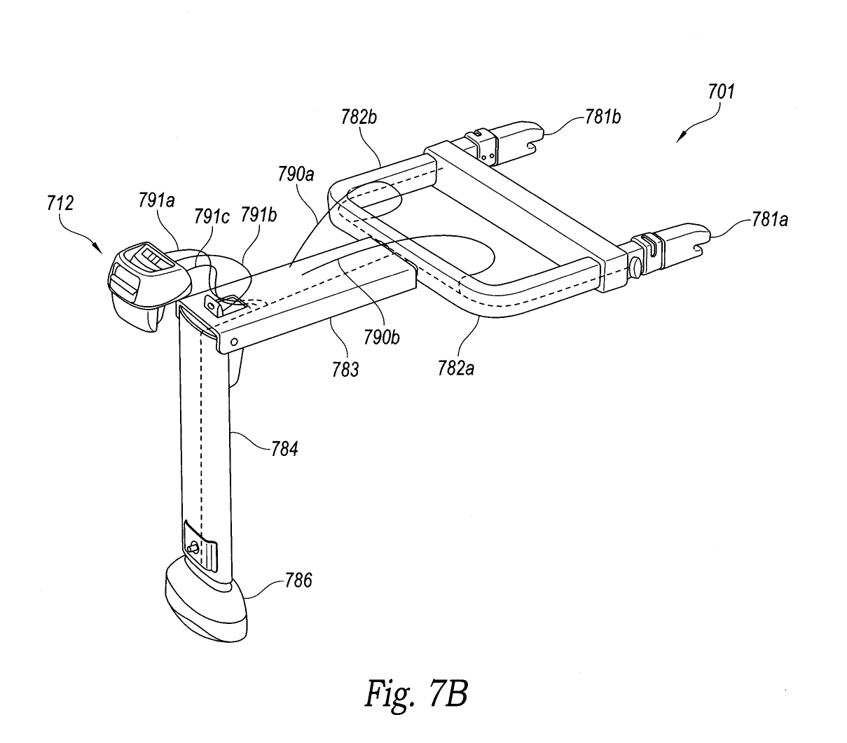

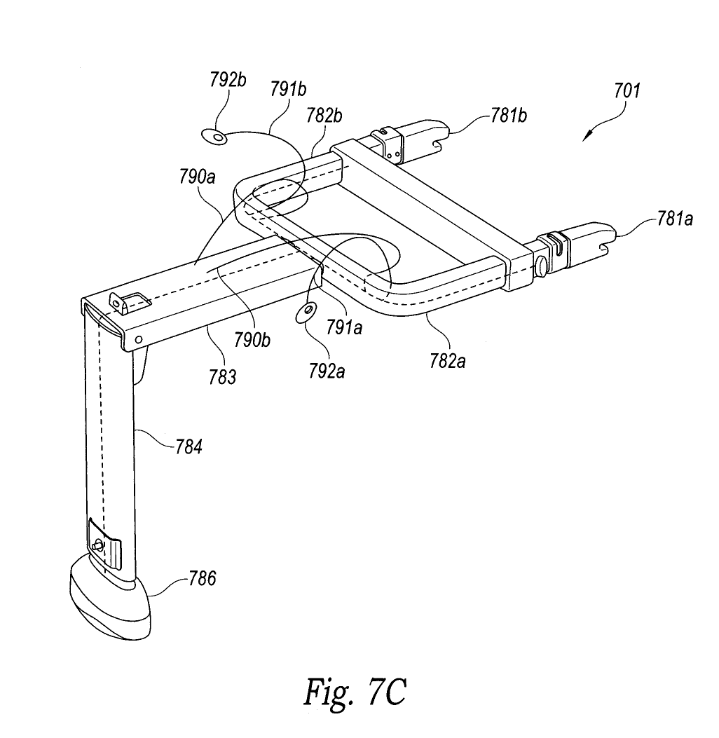

FIGS. 7A-7C illustrate a safety seat support frame 701 configured in accordance with other embodiments of the disclosure. The support frame 701 can support a safety seat (e.g. the child seat 101 of FIG. 1) in a conventional manner. The support frame 701 can also be used to securely attach the safety seat to a vehicle seat by connecting to a conventional pre-installed anchor system (not shown; referred to herein as the “anchor system”). In the illustrated embodiments of FIGS. 7A-7C, the support frame 701 is configured for connection to an ISOFIX anchor system. In other embodiments, however, the support frame 701 can be configured for connection to, for example, LATCH (Lower Anchors and Tethers for Children) and/or LUAS (Lower Universal Anchorage System) anchor systems. In further embodiments, the safety seat support frame may be configured for connection to any other suitable anchor system known in the art.

Referring first to FIG. 7A, the support frame 701 has support arms 782 (identified separately as a first support arm 782a and a second support arm 782b) attached to a support leg 783, which is joined to an upper portion of a leg 784 at a generally perpendicular angle. A foot 786 can be mounted to a lower portion of the leg 784 onto a floor section of the vehicle (not shown). The foot 786 can be positioned in front of the seat in a conventional manner. The support arms 782 include a first connector 781a and a second connector 781b that can be releasably attached to the anchor system. A first connector wire 790a and a second connector wire 790b electrically couple the first connector 781a and the second connector 781b to a lever (not shown) on the safety seat 101 (FIG. 1). The first connector wire 790a and the second connector wire 790b can be configured to relay a signal to the first connector 781a and the second connector 781b whereupon the first connector 781a and/or second connector 781b disengage the anchor system. In addition, one or more interface wires 791 (referred to individually as a first interface wire 791a, a second interface wire 791b, and a third interface wire 791c) can be configured to relay signals of a locking status of the first connector 781a, the second connector 781b, and/or the foot 786 to a user interface 794.

In the illustrated embodiment of FIG. 7A, the user interface 794 can be at least partially disposed on a buckle assembly 711. One or more interface indicators 795 (referred to separately as a first interface indicator 795a, a second interface indicator 795b, and a third interface indicator 795c) are disposed on the user interface 794 and can be configured to correspond to any number of status inputs. For example, the indicator interface 795 can display the locked/unlocked status of the first connector 781a and the second connector 781b, and/or the foot 786. In the illustrated embodiment of FIG. 7B, the user interface 794 is disposed onto a notification panel 712 at least adjacent to the leg 784.

In the embodiment of FIG. 7C, status information can be transmitted to one or more indicators 792 (identified separately as a first indicator 792a and a second indicator 792b) via the interface wires 791. The indicators 792 can be configured to function similarly to, for example, the first indicator 652 and the second indicator 654 discussed in reference to FIG. 6. The indicators 792 can include, for example, a light emitting diode (LED) or another light source, and can be configured to activate based on one or more status conditions. For example, the indicators 792 can be configured to visually display different colors depending on the latched/released status of the first connector 781a, the second connector 781b, and/or the foot 786. If, for example, all three of the first connector 781a, the second connector 781b, and/or the foot 786 are properly secured to the anchor system and/or vehicle seat, the second indicator 654 may display a first color (e.g. a green color). The indicators 792 can be disposed anywhere on the support frame 701 and/or on the child seat.

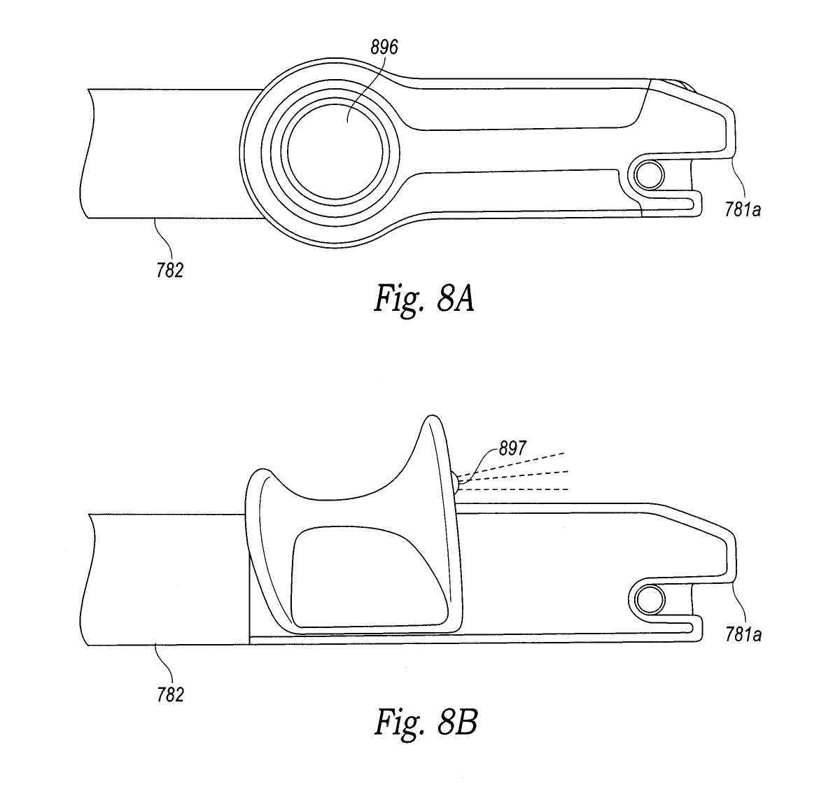

FIGS. 8A and 8B are enlarged views of the connectors 781a configured in accordance with other embodiments of the invention. In the illustrated embodiment of FIG. 8A, a proximal portion of the support arm 782 is coupled to a distal end portion of the connector 781a, on the side of which is disposed a first indicator 896 (e.g. a light source or an LED. The first indicator 896 can be configured to display a first color, for example green, when the connector 781a is properly attached to the anchor system (not shown) and/or a second color, for example red, when the connector 781a is not attached to the anchor system. In other embodiments, the first indicator 896 can be configured to display other colors.

In the illustrated embodiment of FIG. 8B, a second indicator 897 is disposed on an upper portion of the connector 781a and can be configured to indicate proper attachment of the connector 781a to the anchor system depending on the status of the connector 781a, as described with respect to FIG. 8A. The second indicator 897 can further be configured to illuminate the connector 781a and/or the anchor system, thereby assisting in the attachment of the support frame 701 to the anchor system. In some embodiments, the first indicator 896 and the second indicator 897 are made from light emitting diodes (LEDs) while in other embodiments, the first indicator 896 and the second indicator 897 can be made from any suitable light source.

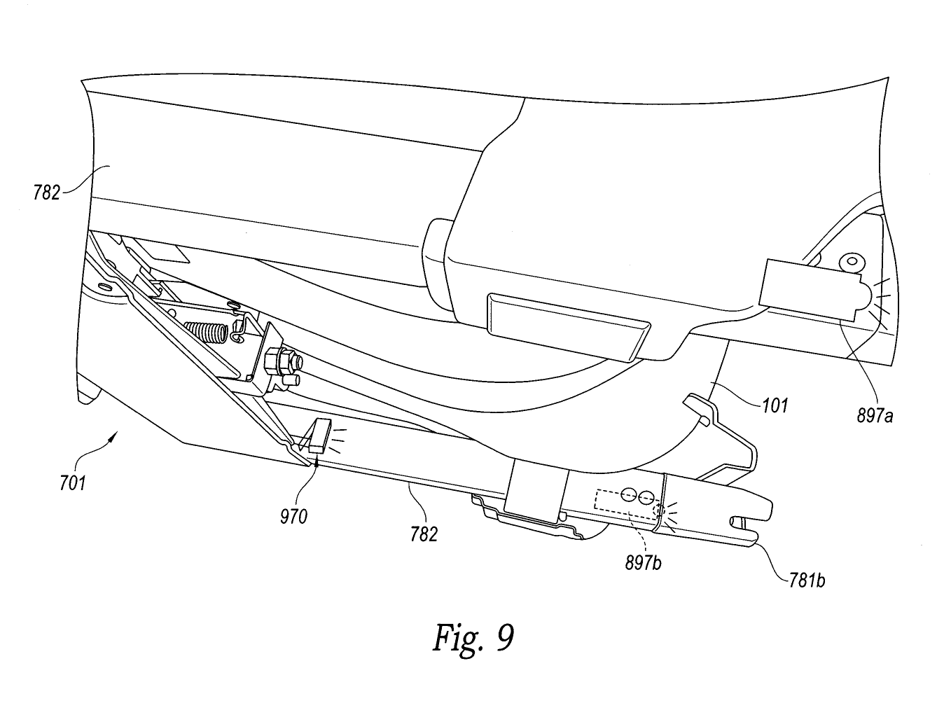

FIG. 9 depicts a view of an underside portion of the support frame 701 releasably joined with the safety seat 101 (FIG. 1) in accordance with further embodiments of the disclosure. A microswitch 970 can be disposed on the second support arm 782b, and can be configured to detect proper attachment of the safety seat 101 to the support frame 701. The microswitch 970 can be coupled to a first indicator 897a (e.g. a first light or other visual indicator) and a second indicator 897b disposed at least adjacent to the first connector 781a and the second connector 781b, respectively. The first indicator 897a and the second indicator 897b can be configured to display a first color if the microswitch 970 is open and/or a second color if the microswitch 970 is closed. Further, in certain other embodiments, the first indicator 897a and the second indicator 897b can be located at any location on the safety seat 101 and/or the support frame 701. Moreover, in some embodiments the first indicator 897a and second indicator 897b can also be auditory indicators (e.g. a beeper or a buzzer).

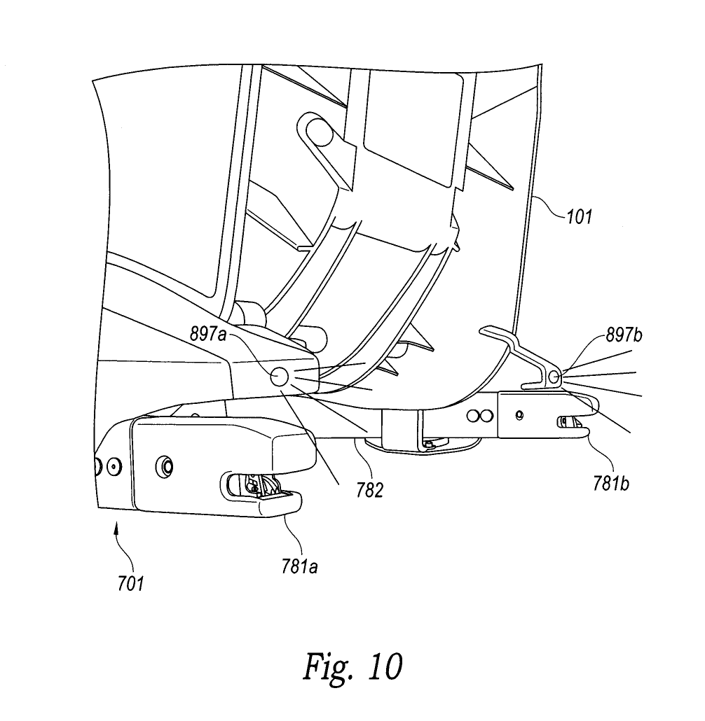

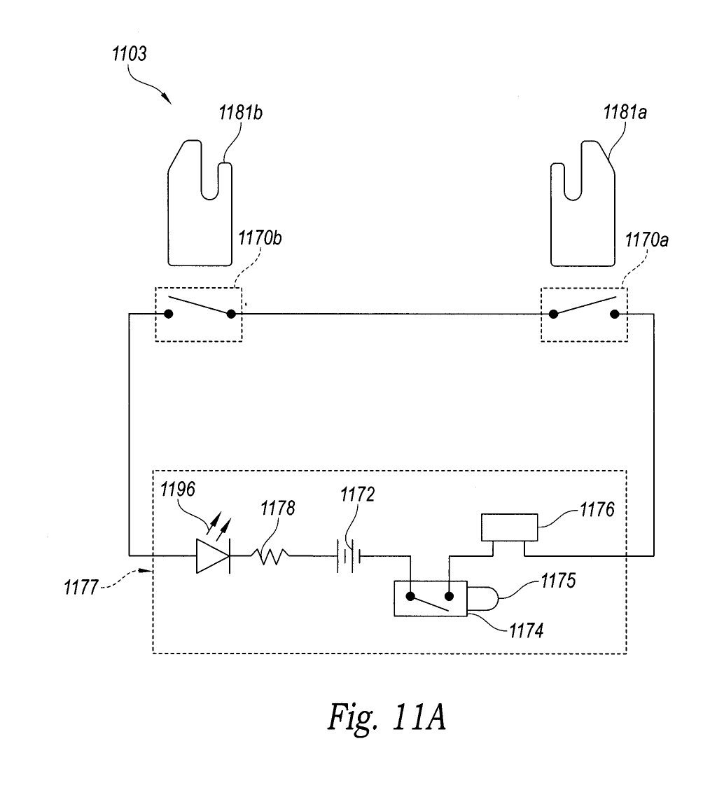

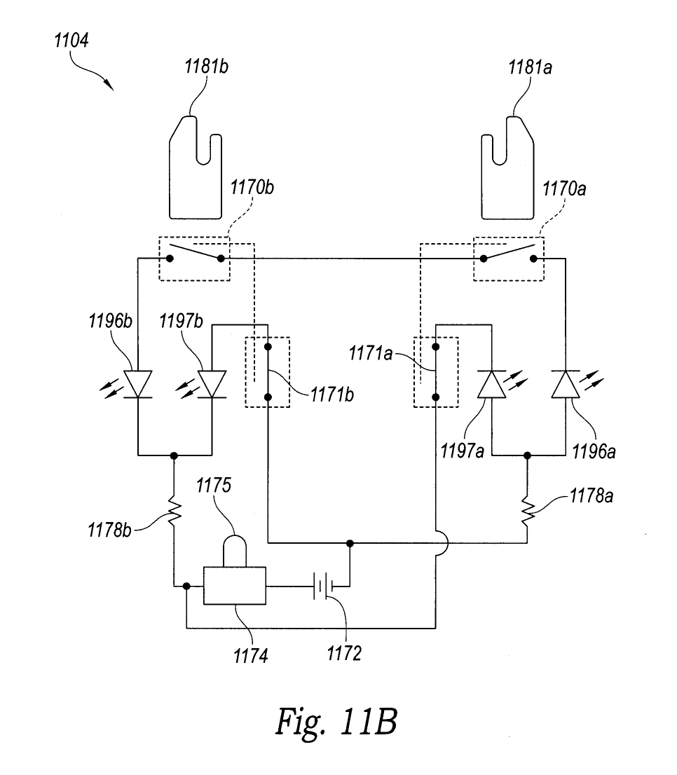

FIG. 10 depicts a rear view of the support frame 701 releasably joined with the safety seat 101 of FIG. 9 configured in accordance with embodiments of the disclosure. In the illustrated embodiment, the first indicator 897a and the second indicator 897b are disposed on a rear portion of the safety seat 101, and releasably attached to the support frame 701. The indicators 897 and can be further configured to illuminate the first connector 781a and the second connector 781b, as described in further detail below with respect to FIG. 11B. Illumination of the first connector 781a and the second connector 781b can assist a user in engaging to the anchor system. In some embodiments, the first indicator 897a and the second indicator 897b can be configured to display a first color after the first connector 781a and the second connector 781b have been properly attached to the anchor system.

FIG. 11A is a schematic diagram 1103 of an electric circuit showing operation of an indicator 1196 configured in accordance with certain embodiments of the disclosure. A control panel 1177 comprises a timer switch 1174 in series connection with a power supply 1172, a resistor 1178, and the indicator 1196. The indicator 1196 can be, for example, a light source (e.g. an LED) configured to display the connection status of the connectors 781 and/or the foot 786. The timer switch 1174 can be closed by the actuation of a push button 1175 operably coupled thereto and can be configured to remain closed for a duration of time T, for example, five minutes. A first microswitch 1170a and a second microswitch 1170b can be configured to close upon proper attachment of a first connector 1181a and a second connector 1181b, respectively, to the anchor system. Closure of both the first microswitch 1170a and the second microswitch 1170b within duration T, can result in current flow to, and thus activation of, the indicator 1196 and a buzzer 1176. The buzzer 1176, when activated, can produce an audible signal, such as a ring or a beep, indicating that the first connector 1181a and the second connector 1181b are properly attached to the anchor system. In the illustrated embodiment, the buzzer 1176 can only be activated within the time T of the actuation of the push button 1175. The timer switch 1174 is configured to open after a duration of time T, preventing current flow to, and thus, activation of the buzzer 1176. However, in other embodiments, the buzzer 1175 can be activated at any time independent of the actuation of the push button 1175. Moreover, in certain embodiments, the buzzer can be a piezoelectric element, while in other embodiments the buzzer can be any electromechanical noise source known in the art.

FIG. 11B is a schematic diagram of an electric circuit 1104 illustrating operation of a first indicator 1196a, a second indicator 1196b, a first illuminator 1197a, and a second illuminator 1197b. Actuation of the push button 1175 activates the timer switch 1174, allowing current to flow through a switch 1171b and a resistor 1178b to the second illuminator 1197b and also through a resistor 1178a to the indicator 1196a for a duration of time U, for example, five minutes. Current flow to the first illuminator 1197a and the second illuminator 1197b may illuminate the first connectors 1181a and the second connector 1181b, respectively, thereby assisting attachment thereof to the anchor system. This attachment results in the closure of the first microswitch 1170a and the second microswitch 1170b, allowing for current flow through the first indicator 1196a and the second indicator 1196b therein causing display of a first color, for example green. The display of the first color by the first indicator 1196a and the second indicator 1196b can confirm to an operator, for example, a parent installing the support frame 701 (not shown) into a vehicle, proper attachment of the support frame 701 to the anchor system. In some embodiments the first switch 1171a and the second switch 1171b can be respectively coupled to the first microswitch 1170a and the second microswitch 1170b and be configured to be open when the microswitches 1170a and 1170b are closed, thereby blocking current flow to the first illuminator 1197a and the second illuminator 1197b after proper attachment of the first connector 781a and the second connector 781b to the anchor system.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the disclosure is not limited, except as by the appended claims.

I/we claim:

1. A buckle assembly for use in a personal restraint system in a vehicle, the buckle assembly comprising:
a connector configured to be operably coupled to one or more webs, wherein the connector includes a tongue portion having a locking feature;
a body configured to receive the tongue portion, wherein the body includes a latch configured to releasably engage the locking feature of the tongue portion when the tongue portion is inserted into the body; and
a casing, wherein the casing includes an interior portion that at least partially encases the body.

2. The buckle assembly of claim 1, further comprising a child safety seat, wherein the webs are configured to restrain a child in the child safety seat.

3. The buckle assembly of claim 1 wherein at least a portion of the casing includes a padded surface.

4. The buckle assembly of claim 1, further comprising a indicator disposed on the casing and configured to activate in response to a change in engagement status of one or more components of the buckle assembly.

5. The buckle assembly of claim 4 wherein the indicator is configured to display the engagement status of the tongue portion of the connector and the latch.

6. The buckle assembly of claim 5 wherein the indicator is a visual indicator.

7. The buckle assembly of claim 1, further comprising a media feature, wherein at least a portion of the media feature is disposed in and/or on the casing.

8. The buckle assembly of claim 7 wherein the media feature includes an audio device.

9. The buckle assembly of claim 7 wherein the media feature includes a video device.

10. The buckle assembly of claim 7 wherein the media feature includes a non-transitory computer readable medium.

11. The buckle assembly of claim 1, wherein the casing further comprises a docking station configured to receive one or more devices.

12. The buckle assembly of claim 11 wherein the docking station is further configured to provide electrical power to one or more devices.

13. The buckle assembly of claim 11 wherein the docking station is further configured to electrically couple one or more devices to an external system.

14. The buckle assembly of claim 13 wherein the external system is capable of displaying audio or video.

15. The buckle assembly of claim 1 wherein the interior portion of the casing at least partially encases the connector.

16. A buckle assembly for use in a child seat of a vehicle, the buckle assembly comprising:
a connector configured to be operably coupled to one or more webs, wherein the connector includes a tongue portion having a locking feature;
a housing configured to receive the tongue portion;
a latch positioned in the housing and configured to engage the locking feature of the tongue portion when the tongue portion is inserted into the housing; and
a status indicator disposed at least proximate to the housing, wherein the status indicator is configured to activate in response to an operating condition of the buckle assembly.

17. The buckle assembly of claim 16 wherein the operating condition is the secure latching of the tongue to the connector.

18. The buckle assembly of claim 16 further comprising an actuator coupled to the latch, wherein actuating the actuator disengages the locking feature of the tongue portion from the latch.

19. The buckle assembly of claim 16 further comprising a padded casing, wherein the casing at least partially surrounds the connector and the housing.

20. The buckle assembly of claim 19 wherein at least a portion of the padded casing is made from soft plastic, artificial rubber, foam, elastomeric material, or fabric.

21. A personal restraint system, the personal restraint system comprising:
a buckle assembly, the buckle assembly including:
a connector configured to be operably coupled to one or more webs, wherein the connector includes a tongue portion having a locking feature;
a housing configured to receive the tongue portion; and
a latch in the housing configured to engage the locking feature of the tongue portion when the tongue portion is inserted into the housing; and
a receptacle configured to accept a media device, wherein the receptacle is operably disposed on the buckle assembly.

22. The receptacle of claim 21, further comprising:
a connection to an electrical power supply source, wherein the media device receives electrical power from the electrical power supply source through the connection; and
a media interface configured to connect the media device to an external display system.

23. A personal restraint system for use with a child safety seat, the personal restraint system comprising:
a support configured to releasably engage the child safety seat;
at least one connector configured to releasably engage an anchor disposed proximate to a seat in the vehicle; and
an indicator operably connected to the connector, wherein the indicator is configured to activate in response to an operating condition of the connector.

24. The personal restraint system of claim 23, further comprising an illuminator disposed proximate to the support.

25. The personal restraint system of claim 24 wherein the illuminator is configured to activate in response to an action of an operator of the personal restraint system.

26. The personal restraint system of claim 23 wherein the indicator is disposed proximate to the safety seat.

27. The personal restraint system of claim 23 further comprising a microswitch coupled to the connector, wherein the microswitch is configured to be closed when the connector is securely engaged to the anchor and configured to be open when the connector is disengaged from the anchor.

28. The personal restraint system of claim 23 wherein the indicator is configured to display a first color when the microswitch is closed and a second color when the microswitch is open.
